(19) United States
(12) Patent Application Publication
(10) Pub. No.: US 2026/0261335 A1
(43) Pub. Date: Sep. 3, 2026

(54) Enhancement of User Equipment Location Verification in Non-Terrestrial Networks

(71) Applicant: Apple Inc., Cupertino, CA (US)

(72) Inventors: Chunxuan Ye, San Diego, CA (US); Dawei Zhang, Saratoga, CA (US); Yuqin Chen, Beijing (CN); Wei Zeng, Saratoga, CA (US); Haitong Sun, Saratoga, CA (US); Hong He, San Jose, CA (US); Chunhai Yao, Beijing (CN); Fangli Xu, Beijing (CN); Haijing Hu, Los Gatos, CA (US); Jie Cui, San Jose, CA (US)

(21) Appl. No.: 19/155,631

(22) PCT Filed: Feb. 14, 2023
(86) PCT No.: PCT/CN2023/075898

§ 371 Date: Aug. 12, 2025

(51) Int. Cl. H04B 7/185; H04W 24/10; H04W 64/00

(52) U.S. Cl. CPC H04B 7/18554; H04W 24/10; H04W 64/006

(57) ABSTRACT

A method may include receiving, from a network node, a configuration message comprising one or more thresholds for multiple round trip time (multi-RTT) measurement reporting. The method may further include receiving downlink (DL) reference signals (RS) and transmitting uplink (UL) reference signals (RS) for the multi-RTT measurements. The method may further include determining respective differences in time between respective reception times of the one or more DL RS and determining whether or not the respective differences in time are less than the one or more thresholds for multi-RTT measurement reporting. If the respective differences in time are determined to be less than the one or more thresholds for multi-RTT measurement reporting, the method may further include transmitting, to a location management function (LMF), one or more round trip time delay (RTTD) reports for the multi-RTT measurements.

### FIELD

The present application relates to wireless communications, and more particularly to systems, apparatuses, and methods for enhanced user equipment location verification in non-terrestrial networks.

### DESCRIPTION OF THE RELATED ART

Wireless communication systems are rapidly growing in usage. Wireless devices, particularly wireless user equipment devices (UEs), have become widespread. Additionally, people are becoming increasingly mobile including international travel. Non-terrestrial networks (NTNs) such as 3GPP satellite networks have increased in usage, in particular during international mobility scenarios. Accordingly, increased reliability and connectivity for UEs using NTNs are desirable.

### SUMMARY

Embodiments are presented herein of apparatuses, systems, and methods for enhanced user equipment location verification in non-terrestrial networks.

According to some embodiments, a method may include receiving, from a network node, a configuration message comprising one or more thresholds for multiple round trip time (multi-RTT) measurement reporting. The method may further include receiving, from the network node, a plurality of downlink (DL) reference signals (RS) for one or more multi-RTT measurements and transmitting, to the network node, a plurality of uplink (UL) reference signals (RS) for the one or more multi-RTT measurements, wherein respective UL RS of the plurality of UL RS are transmitted in response to receiving respective DL RS of the plurality of DL RS. Additionally, the method may include determining one or more respective differences in time between at least one of respective reception times of the plurality of DL RS and determining whether or not the one or more respective differences in time are less than the one or more thresholds for multi-RTT measurement reporting. Furthermore, if the one or more respective differences in time are less than the one or more thresholds for multi-RTT measurement reporting, the method may further include transmitting, to a location management function (LMF), one or more round trip time delay (RTTD) reports for the one or more multi-RTT measurements.

In some embodiments, a first threshold of the one or more thresholds may be associated with an upper bound of a total measurement duration and a second threshold of the one or more thresholds may correspond to an upper bound of two consecutive measurements for the total measurement duration. Additionally or alternatively, wherein the one or more thresholds are based on at least one of one or more satellite altitudes, one or more satellite total coverage durations, and one or more satellite elevation angles.

According to further embodiments, the plurality of DL RS may be positioning reference signals (PRS) and the plurality of UL RS may be sounding reference signals (SRS). In some embodiments, respective RTTD reports of the one or more RTTD reports may be transmitted to the LMF after respective transmissions of the one or more UL RS or a RTTD report of the one or more RTTD reports may be transmitted to the LMF after the one or more UL RS have been transmitted. Additionally or alternatively, respective RTTD reports of the one or more RTTD reports may include respective timestamps.

In some embodiments, the method may further include determining one or more additional differences in time between at least one of respective reception times of the plurality of DL RS and respective transmission times of the plurality of UL RS. Additionally, the method may include determining whether or not the one or more additional differences in time are less than the one or more thresholds for multi-RTT measurement reporting. If the one or more additional differences in time are less than the one or more thresholds for multi-RTT measurement reporting, the method may further include transmitting, to the LMF, the one or more RTTD reports for the one or more multi-RTT measurements, according to some embodiments.

According to further embodiments, a method may include receiving, from a network node, one or more messages including at least one of a configuration of a satellite orbit plane range and satellite orbital information. The method may further include determining, using a global navigation satellite system (GNSS), a location of a user equipment (UE). The method may include determining, based at least in part on one or more of the satellite orbit plane range, the satellite orbital information, and the location of the UE, whether or not the location of the UE is within the satellite orbit plane range. Additionally, the method may include reporting, to the network node, an indication of whether or not the location of the UE is within the satellite orbit plane range and receiving, from the network node, a notification of a decision regarding the location of the UE.

In some embodiments, the one or more messages may be received via system information broadcast (SIB) signaling or dedicated radio resource control (RRC) signaling. Additionally or alternatively, the configuration of the satellite orbit plane range may specify a range of the satellite orbit on the ground in meters (m) or kilometers (km). In some embodiments, the one or more messages may include a plurality of satellite orbit plane ranges.

According to further embodiments, the method may further include calculating, using the satellite orbital information and the location of the UE, a minimum distance and comparing the minimum distance to the configured satellite orbit plane range. Accordingly, if the minimum distance is smaller than the configured satellite orbit plane range, the UE may be within the configured satellite orbit plane range or if the minimum distance is greater than the configured satellite orbit plane range, the UE may be outside the configured satellite orbit plane range.

According to some embodiments, the indication may be included in a single bit to indicate whether or not the UE is within the satellite orbit plane range. Additionally or alternatively, the indication may be included in multiple bits to indicate at which level the UE is within the satellite orbit plane range, according to some embodiments. In some embodiments, the indication may be transmitted via dedicated radio resource control (RRC) signaling or medium access control-control element (MAC-CE) signaling.

In some embodiments, a method may include transmitting, to a user equipment (UE), at least one of a configuration of a satellite orbit plane range and satellite orbital information. The method may further include receiving, from the UE, a location of the UE and determining, based at least in part on one or more of the satellite orbit plane range, the satellite orbital information, and the location of the UE, whether or not the UE is within the satellite orbit plane range. Accordingly, if the UE's location is determined to be outside the satellite orbit plane range, the method may further include performing multilateration positioning to verify the location of the UE. Additionally or alternatively, if the UE's location is determined to be outside the satellite orbit plane range, the method may further include transmitting, to the UE via dedicated radio resource control (RRC) signaling, an indication to the UE indicating a verification of the location of the UE.

Note that the techniques described herein may be implemented in and/or used with a number of different types of devices, including but not limited to base stations, access points, cellular phones, portable media players, tablet computers, wearable devices, unmanned aerial vehicles, unmanned aerial controllers, automobiles and/or motorized vehicles, and various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings, in which:

FIG. 1 illustrates an example wireless communication system, according to some embodiments;

FIG. 2 illustrates a base station (BS) in communication with a user equipment (UE) device, according to some embodiments;

FIG. 3 illustrates an example block diagram of a UE, according to some embodiments;

FIG. 4 illustrates an example block diagram of a BS, according to some embodiments;

FIG. 5 is a network infrastructure diagram illustrating a 3GPP satellite network deployment, according to some embodiments;

FIGS. 6A and 6B are schematic diagrams illustrating interworking between 3GPP terrestrial and satellite (e.g., non-terrestrial) radio access networks (RANs), according to some embodiments; and

FIG. 7 illustrates an example non-terrestrial network (NTN) spanning multiple countries, according to some embodiments.

FIG. 8 illustrates aspects of an example method for determining a target device location in a terrestrial network, according to some embodiments.

FIG. 9 is a flowchart diagram illustrating an example method for enhanced location verification for non-terrestrial networks, according to some embodiments.

FIGS. 10A and 10B illustrate examples of enhanced round trip time delay (RTTD) reporting techniques, according to some embodiments.

FIG. 11 is a flowchart diagram illustrating an example method for enhanced location verification for UEs near or within satellite orbit planes, according to some embodiments.

FIG. 12 illustrates example aspects of location verification and configuration for UEs located near or within a satellite orbit plane, according to some embodiments.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

### Acronyms

Various acronyms are used throughout the present disclosure. Definitions of the most prominently used acronyms that may appear throughout the present disclosure are provided below:
UE: User Equipment
NW: Network
RF: Radio Frequency
GSM: Global System for Mobile Communication
UMTS: Universal Mobile Telecommunication System
EUTRA: Evolved UMTS Terrestrial Radio Access
LTE: Long Term Evolution
NR: New Radio
TX: Transmission/Transmit
RX: Reception/Receive
RAT: Radio Access Technology
RAN: Radio Access Network
NG-RAN: Next Generation Radio Access Network
RRC: Radio Resource Control
RTT: Round Trip Time
GW: Gateway
NTN: Non-Terrestrial Network
TN: Terrestrial Network
SIB: System Information Block
SIB1: System Information Block-1
LEO: Low Earth Orbit
MEO: Medium Earth Orbit
GEO: Geosynchronous Earth Orbit
NGSO: Non-Geostationary Satellite Orbit
UAV: Unmanned Aerial Vehicle
AS: Access Stratum
NAS: Non-Access Stratum
PLMN: Public Land Mobility Network
TAC: Tracking Area Code
GNSS: Global Navigation Satellite System
AMF: Access and Mobility Function
LMF: Location Management Function
SFN: System Frame Number
UTC: Coordinated Universal Time
DL: Downlink
UL: Uplink
TOA: Time of Arrival
TDOA: Time Difference of Arrival
OTDOA: Observed Time Difference of Arrival
SRS: Sounding Reference Signal
PRS: Positioning Reference Signal
gNB: Next Generation Node-B
RSRP: Reference Signal Received Power
TRP: Transmission and Reception Point
RTTD: Round Trip Time Delay
AoA: Angle of Arrival
MAC-CE: Medium Access Control-Control Element

### Terms

The following is a glossary of terms that may appear in the present disclosure:

Memory Medium—Any of various types of non-transitory memory devices or storage devices. The term “memory medium” is intended to include an installation medium, e.g., a CD-ROM, floppy disks, or tape device; a computer system memory or random-access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer system for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” may be broadly defined to encompass any device (or combination of devices) having at least one processor that executes instructions from a memory medium.

User Equipment (UE) (or “UE Device”)—any of various types of computer systems or devices that are mobile or portable and that perform wireless communications. Examples of UE devices include mobile telephones or smart phones (e.g., iPhone™, Android™-based phones), tablet computers (e.g., iPad™, Samsung Galaxy™), portable gaming devices (e.g., Nintendo DS™, PlayStation Portable™, Gameboy Advance™, iPhone™), wearable devices (e.g., smart watch, smart glasses), laptops, PDAs, portable Internet devices, music players, data storage devices, other handheld devices, automobiles and/or motor vehicles, unmanned aerial vehicles (UAVs) (e.g., drones), UAV controllers (UACs), etc. In general, the term “UE” or “UE device” can be broadly defined to encompass any electronic, computing, and/or telecommunications device (or combination of devices) which is easily transported by a user and capable of wireless communication.

Wireless Device—any of various types of computer systems or devices that perform wireless communications. A wireless device can be portable (or mobile) or may be stationary or fixed at a certain location. A UE is an example of a wireless device.

Communication Device—any of various types of computer systems or devices that perform communications, where the communications can be wired or wireless. A communication device can be portable (or mobile) or may be stationary or fixed at a certain location. A wireless device is an example of a communication device. A UE is another example of a communication device.

Base Station (BS)—The term “Base Station” has the full breadth of its ordinary meaning, and at least includes a wireless communication station installed at a fixed location and used to communicate as part of a wireless telephone system or radio system.

Processing Element (or Processor)—refers to various elements or combinations of elements that are capable of performing a function in a device, e.g., in a user equipment device or in a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

Wi-Fi—The term “Wi-Fi” has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.

Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112, paragraph six, interpretation for that component.

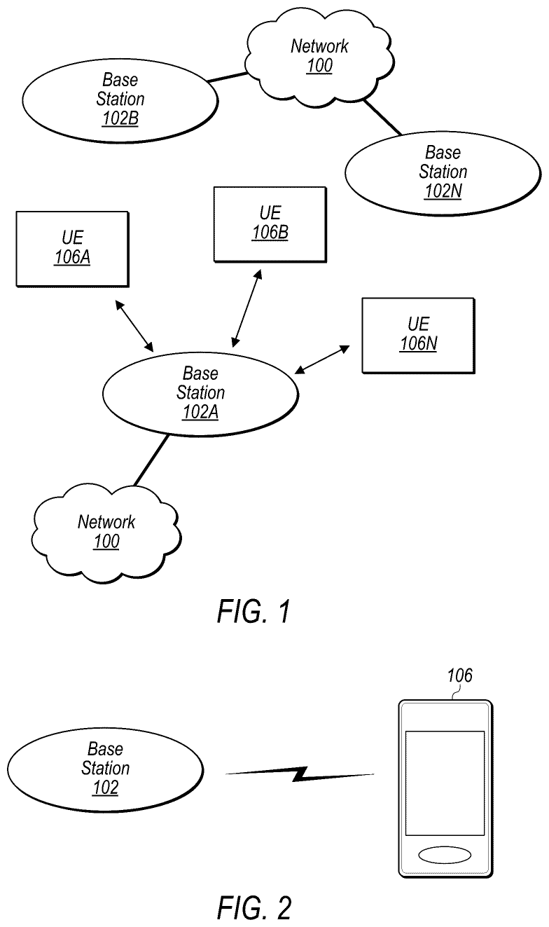

### FIGS. 1 and 2—Exemplary Communication System

FIG. 1 illustrates an exemplary (and simplified) wireless communication system in which aspects of this disclosure may be implemented, according to some embodiments. It is noted that the system of FIG. 1 is merely one example of a possible system, and embodiments may be implemented in any of various systems, as desired.

As shown, the exemplary wireless communication system includes a base station 102 which communicates over a transmission medium with one or more (e.g., an arbitrary number of) user devices 106A, 106B, etc. through 106N. Each of the user devices may be referred to herein as a “user equipment” (UE) or UE device. Thus, the user devices 106 are referred to as UEs or UE devices.

The base station 102 may be a base transceiver station (BTS) or cell site, and may include hardware and/or software that enables wireless communication with the UEs 106A through 106N. If the base station 102 is implemented in the context of LTE, it may alternately be referred to as an ‘eNodeB’ or ‘eNB’. If the base station 102 is implemented in the context of 5G NR, it may alternately be referred to as a ‘gNodeB’ or ‘gNB’. The base station 102 may also be equipped to communicate with a network 100 (e.g., a core network of a cellular service provider, a telecommunication network such as a public switched telephone network (PSTN), and/or the Internet, among various possibilities). Thus, the base station 102 may facilitate communication among the user devices and/or between the user devices and the network 100. The communication area (or coverage area) of the base station may be referred to as a “cell.” As also used herein, from the perspective of UEs, a base station may sometimes be considered as representing the network insofar as uplink and downlink communications of the UE are concerned. Thus, a UE communicating with one or more base stations in the network may also be interpreted as the UE communicating with the network.

The base station 102 and the user devices may be configured to communicate over the transmission medium using any of various radio access technologies (RATs), also referred to as wireless communication technologies, or telecommunication standards, such as GSM, UMTS (WCDMA), LTE, LTE-Advanced (LTE-A), LAA/LTE-U, 5G NR, 3GPP2 CDMA2000 (e.g., 1x RTT, 1xEV-DO, HRPD, eHRPD), Wi-Fi, etc.

Base station 102 and other similar base stations operating according to the same or a different cellular communication standard may thus be provided as one or more networks of cells, which may provide continuous or nearly continuous overlapping service to UE 106 and similar devices over a geographic area via one or more cellular communication standards.

Note that a UE 106 may be capable of communicating using multiple wireless communication standards. For example, a UE 106 might be configured to communicate using either or both of a 3GPP cellular communication standard or a 3GPP2 cellular communication standard. In some embodiments, the UE 106 may be configured to perform techniques for enhancing timing relationships in non-terrestrial networks (NTNs), such as according to the various methods described herein. The UE 106 might also or alternatively be configured to communicate using WLAN, BLUETOOTH™, one or more global navigational satellite systems (GNSS, e.g., GPS or GLONASS), one and/or more mobile television broadcasting standards (e.g., ATSC-M/H), etc. Other combinations of wireless communication standards (including more than two wireless communication standards) are also possible.

FIG. 2 illustrates an exemplary user equipment 106 (e.g., one of the devices 106A through 106N) in communication with the base station 102, according to some embodiments. The UE 106 may be a device with wireless network connectivity such as a mobile phone, a hand-held device, a wearable device, a computer or a tablet, an unmanned aerial vehicle (UAV), an unmanned aerial controller (UAC), an automobile, or virtually any type of wireless device. The UE 106 may include a processor (processing element) that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array), an integrated circuit, and/or any of various other possible hardware components that are configured to perform (e.g., individually or in combination) any of the method embodiments described herein, or any portion of any of the method embodiments described herein. The UE 106 may be configured to communicate using any of multiple wireless communication protocols. For example, the UE 106 may be configured to communicate using two or more of CDMA2000, LTE, LTE-A, 5G NR, WLAN, or GNSS. Other combinations of wireless communication standards are also possible.

The UE 106 may include one or more antennas for communicating using one or more wireless communication protocols according to one or more RAT standards. In some embodiments, the UE 106 may share one or more parts of a receive chain and/or transmit chain between multiple wireless communication standards. The shared radio may include a single antenna, or may include multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware.

In some embodiments, the UE 106 may include separate transmit and/or receive chains (e.g., including separate antennas and other radio components) for each wireless communication protocol with which it is configured to communicate. As a further possibility, the UE 106 may include one or more radios that are shared between multiple wireless communication protocols, and one or more radios that are used exclusively by a single wireless communication protocol. For example, the UE 106 may include a shared radio for communicating using either of LTE or CDMA2000 1x RTT (or LTE or NR, or LTE or GSM), and separate radios for communicating using each of Wi-Fi and BLUETOOTH™M. Other configurations are also possible.

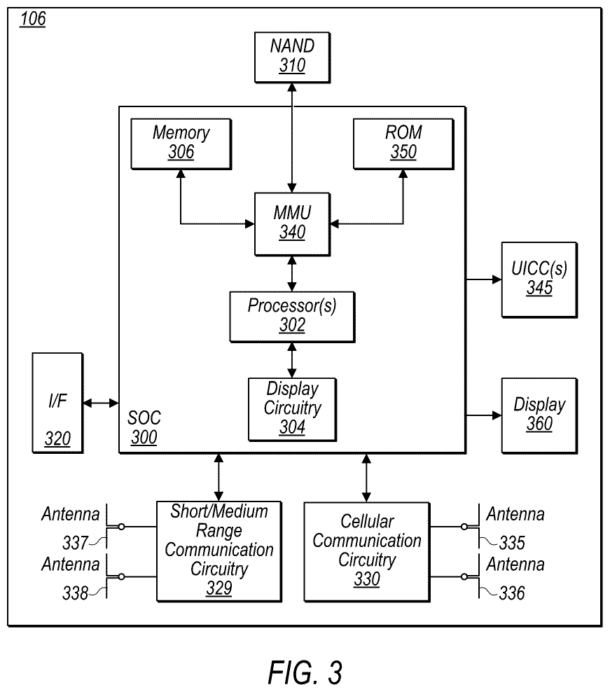

### FIG. 3—Block Diagram of a UE Device

FIG. 3 illustrates a block diagram of an example UE 106, according to some embodiments. As shown, the UE 106 may include a system on chip (SOC) 300, which may include portions for various purposes. For example, as shown, the SOC 300 may include processor(s) 302 which may execute program instructions for the UE 106 and display circuitry 304 which may perform graphics processing and provide display signals to the display 360. In some implementations, the display 360 may include a touchscreen capable of detecting user input, e.g., as touch events. The SOC 300 may also include sensor circuitry 370, which may include components for sensing or measuring any of a variety of possible characteristics or parameters of the UE 106. For example, the sensor circuitry 370 may include motion sensing circuitry configured to detect motion of the UE 106, for example using a gyroscope, accelerometer, and/or any of various other motion sensing components. As another possibility, the sensor circuitry 370 may include one or more temperature sensing components, for example for measuring the temperature of each of one or more antenna panels and/or other components of the UE 106. Any of various other possible types of sensor circuitry may also or alternatively be included in UE 106, as desired. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, radio 330, connector interface (I/F) 320, and/or display 360. The MMU 340 may be configured to perform memory protection and page table translation or set up. In some embodiments, the MMU 340 may be included as a portion of the processor(s) 302.

As shown, the SOC 300 may be coupled to various other circuits of the UE 106. For example, the UE 106 may include various types of memory (e.g., including NAND flash 310), a connector interface 320 (e.g., for coupling to a computer system, dock, charging station, etc.), the display 360, and wireless communication circuitry 330 (e.g., for LTE, LTE-A, NR, CDMA2000, BLUETOOTH™, Wi-Fi, GPS, etc.). The UE device 106 may include at least one antenna (e.g., 335a), and possibly multiple antennas (e.g., illustrated by antennas 335a and 335b), for performing wireless communication with base stations and/or other devices. Antennas 335a and 335b are shown by way of example, and UE device 106 may include fewer or more antennas. Overall, the one or more antennas are collectively referred to as antenna 335. For example, the UE device 106 may use antenna 335 to perform the wireless communication with the aid of radio circuitry 330. As noted above, the UE may be configured to communicate wirelessly using multiple wireless communication standards in some embodiments.

The UE 106 may include hardware and software components for implementing methods for the UE 106 to enhance communication coordination and power saving techniques in NTNs, such as described further subsequently herein. The processor(s) 302 of the UE device 106 may be configured to implement part or all of the methods described herein, e.g., by executing program instructions stored on a memory medium (e.g., a non-transitory computer-readable memory medium). In other embodiments, processor(s) 302 may be configured as a programmable hardware element, such as an FPGA (Field Programmable Gate Array), or as an ASIC (Application Specific Integrated Circuit). Furthermore, processor(s) 302 may be coupled to and/or may interoperate with other components as shown in FIG. 3, to enhance communication coordination and power saving techniques in NTNs according to various embodiments disclosed herein. Processor(s) 302 may also implement various other applications and/or end-user applications running on UE 106.

In some embodiments, radio 330 may include separate controllers dedicated to controlling communications for various respective RAT standards. For example, as shown in FIG. 3, radio 330 (e.g., cellular communication circuitry) may include a Wi-Fi controller, a cellular controller (e.g., LTE, LTE-A, and/or NR controller), and BLUETOOTH™ controller, and in at least some embodiments, one or more or all of these controllers may be implemented as respective integrated circuits (ICs or chips, for short) in communication with each other and with SOC 300 (and more specifically with processor(s) 302). According to some embodiments, radio 330 may be utilized to communicate with one or more NTNs. While three separate controllers are illustrated within radio 330, other embodiments have fewer or more similar controllers for various different RATs that may be implemented in UE device 106.

Further, embodiments in which controllers may implement functionality associated with multiple radio access technologies are also envisioned. For example, according to some embodiments, the cellular controller 354 may, in addition to hardware and/or software components for performing cellular communication, include hardware and/or software components for performing one or more activities associated with Wi-Fi, such as Wi-Fi preamble detection, and/or generation and transmission of Wi-Fi physical layer preamble signals.

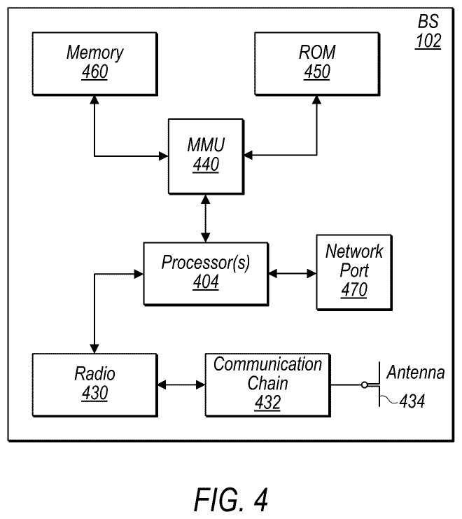

### FIG. 4—Block Diagram of a Base Station

FIG. 4 illustrates a block diagram of an example base station 102, according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2. The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

The base station 102 may include at least one antenna 434, and possibly multiple antennas. The antenna(s) 434 may be configured to operate as a wireless transceiver and may be further configured to communicate with UE device 106 via radio 430. The antenna(s) 434 communicates with the radio 430 via communication chain 432. Communication chain 432 may be a receive chain, a transmit chain or both. The radio 430 may be designed to communicate via various wireless telecommunication standards, including, but not limited to, NR, LTE, LTE-A WCDMA, CDMA2000, etc. The processor 404 of the base station 102 may be configured to implement and/or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. In the case of certain RATs, for example Wi-Fi, base station 102 may be designed as an access point (AP), in which case network port 470 may be implemented to provide access to a wide area network and/or local area network(s), e.g., it may include at least one Ethernet port, and radio 430 may be designed to communicate according to the Wi-Fi standard.

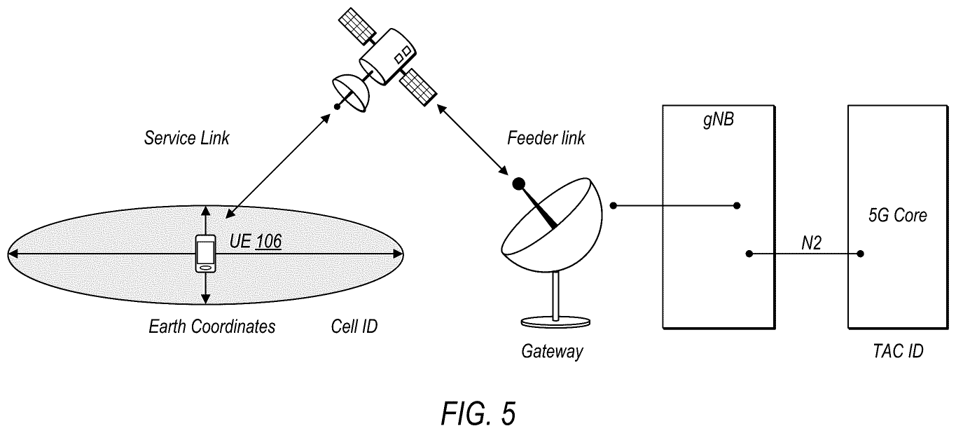

### FIGS. 5-8—3GPP Satellite Network Infrastructure and Location Verification

FIG. 5 is a network infrastructure diagram illustrating a 3GPP satellite network deployment, according to some embodiments. As illustrated, a satellite broadcasts a service link to a UE, such as UE 106, where the UE is operating within a cell (e.g., of a NTN). The satellite also conducts communications with a terrestrial gateway via a feeder link, and the gateway is in turn communicatively coupled to a base station (e.g., a gNB). In some embodiments, the base station may be implemented as a combination of a NTN payload and a NTN gateway.

According to some embodiments, a network node of the NTN may be in the form of a satellite in communication with a UE. For example, as shown in FIG. 5, UE 106 may be configured to communicate directly with the NTN instead of or in addition to communicating with the terrestrial network of the gNB. Accordingly, the network node (e.g., satellite) may provide NTN configuration information to the UE similar to that of a base station providing TN configuration information.

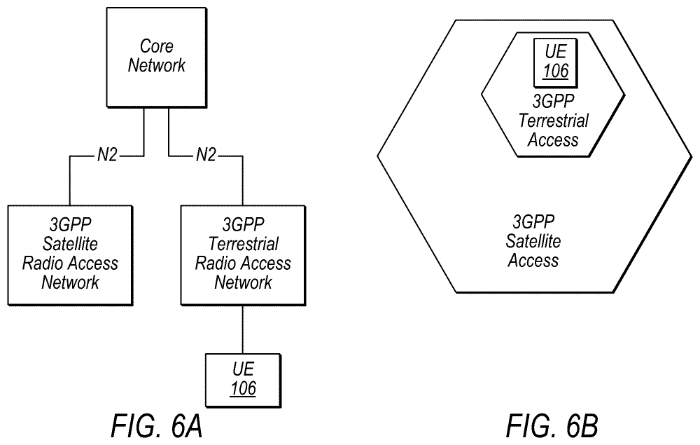

FIGS. 6A and 6B illustrate interworking between 3GPP terrestrial and satellite (e.g., non-terrestrial) radio access networks (RANs), according to some embodiments. As illustrated, in FIG. 6A, a UE 106 communicates with a 3GPP terrestrial RAN, e.g., through a gNB as shown in FIGS. 1-2. The 3GPP terrestrial RAN is coupled via an N2 interface with a core network, and a 3GPP satellite RAN is also coupled to the core network via the N2 interface. FIG. 6B illustrates a UE 106 operating with a cell to obtain 3GPP terrestrial access. The UE 106 also operates within a broader geographic range that provides 3GPP satellite access. It will be appreciated that a UE may communicate directly with the NTN RAN, e.g., instead of or in addition to communicating with the terrestrial RAN.

According to some embodiments, a NTN cell may not be directly associated with (e.g., is distinct from) a PLMN available to the UE (e.g., via the TN). However, in some embodiments, a cell of the NTN may overlap a geographic area that includes cells of a PLMN (e.g., corresponding to the TN). Accordingly, the NTN may be configured to provide location information (which may pertain to a geographic area corresponding to a PLMN of the TN) useable by the UE for purposes of cell reselection. In some embodiments, the UE may be connected to the NTN and upon receiving cell reselection information, may perform a cell reselection procedure to connect to the TN which may be prioritized over the NTN.

As diverse network technologies are integrated with more traditional cellular network technologies, new network characteristics may arise. As one example, introducing new classes of cellular base stations or repeater stations may introduce propagation delays that are noticeably greater, and noticeably more variable, than those associated with more traditional base stations.

For example, 3GPP has recently expanded to define non-terrestrial networks (NTN) within the 3GPP ecosystem. In such systems, propagation delays between a UE, such as the UE 106, and a non-terrestrial network may be far greater than propagation delays between the UE and a traditional terrestrial base station, because a satellite may be far from the terrestrial UE, relative to distances experienced in terrestrial networks. Additionally, such systems may include cells covering larger geographic areas than traditional cells, which may lead to a large differential in propagation delays at two points within a cell (e.g., of the NTN). Moreover, as NR has developed, NR NTN cells have been designed to cover large areas and accordingly the associated NTN may have hundreds of neighboring TN cells. For example, as discussed in 3GPP TR 38.821, scenario parameters describe the max beam footprint size for geosynchronous Earth orbit (GEO) and low Earth orbit (LEO) satellites to be on the order of 3500 km and 1000 km, respectively. For example, the max beam footprint size may correspond to a cell length of an elliptical beam footprint. In other words, the max beam footprint size may be equivalent to twice the major axis of the ellipse corresponding to the beam footprint. Thus, one NTN cell may neighbor (and/or overlap with) many TN cells.

Furthermore, due to increased cellular network demand in atypical or remote locations, it is expected that operators may offer, by themselves or via roaming agreements, cellular service in both NTN and terrestrial network (TN) systems. In some scenarios, NTN systems may be more likely to be used in areas where there are very few or no TN cells present. For example, UEs may utilize NTN systems when in inaccessible terrains such as mountains, forests or in maritime environments (e.g., cruise ships, cargo ships, oil tankers). According to some embodiments, NTNs and TNs may operate in different frequency bands (e.g., frequency range 1 (FR1) and frequency range 2 (FR2). Additionally, as TN and NTN frequency bands may be distinct, UEs may prioritize the associated TN frequency bands over NTN frequency bands or vice versa, according to some embodiments.

A majority of NTN UEs may be geographically aware of their physical location due to being equipped with global navigation satellite system (GNSS) hardware and/or software. Additionally and due to factors associated with the orbits and subsequent coverage areas of the NTN, UEs in these scenarios or environments may be more prone to receiving or determining less accurate location data. For example, UE's experiencing clock drift, mirror-image related ambiguities, and/or UEs near or within the satellite orbit plane range may be scenarios in which the location information of the UE is less accurate and may further need to be verified. Accordingly, it may be beneficial from both the network and UE perspectives to implement location verification enhancements to allow for more accurate location information of UEs in conditions such as these. Furthermore, the NTN network may be able to broadcast multiple public land mobility network (PLMN) and multiple tracking area codes (TACs) per PLMN in one cell. For example, the NTN may be able to transmit up to 12 TACs per PLMN in one cell, according to some embodiments. In some scenarios, a UE may not be expected to perform a registration procedure if one of the currently broadcast TACs belongs to the UE's registration area.

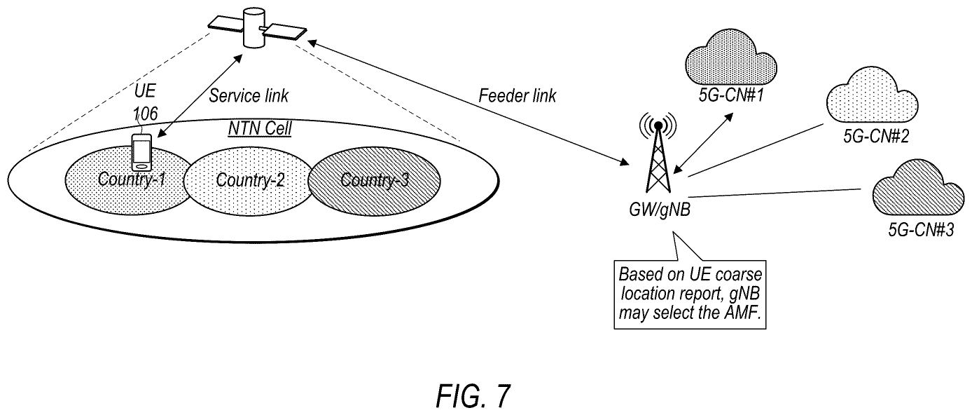

FIG. 7 illustrates an example NTN spanning multiple countries, according to some embodiments. For example, the NTN cell may cover wider radio cells than that of TN cells. Accordingly, the coverage of an NTN cell or an NTN beam may typically be much larger than the cell in the terrestrial networks. Furthermore, the coverage of an NTN cell may span across multiple countries. For example, due to the size of some NTN cells over areas or continents containing numerous and/or relatively smaller countries (e.g., central Europe, for example), multiple countries may be able to access or support the same NTN cell. FIG. 7 also illustrates an example scenario in which UE 106 is operating in Country-1 which is provided cellular coverage via a service link along with Country-2 and Country-3. Additionally, the NTN satellite may be connected to a gateway (GW) or next generation node-B (gNB) via a feeder link. This GW/gNB may provide terrestrial network coverage to the multiple countries as shown by 5G-CN #1 (corresponding to Country-1), 5G-CN #2 (corresponding to Country-2), and 5G-CN #3 (corresponding to Country-3), according to some embodiments.

In some instances, a UE may report its coarse UE location information (coarse GNSS coordinates with an accuracy of approximately 2 km) to a next generation radio access network (NG-RAN) based on a request from the network. In some embodiments, the UE may provide the UE coarse location report after access stratum (AS) security has been established in a connected mode. Furthermore, the gateway (GW) or next generation node-B (gNB) may then perform access and mobility function (AMF) selection based on the UE coarse location report, according to some embodiments. Additionally, when the NG-RAN node is configured to ensure that the selected AMF serves the country where the UE is located, as described in TS 23.501[8], the NG-RAN node may take into account the UE location information when determining the AMF (if said location information is available).

According to some embodiments, there may be motivation to perform NW verification of the UE location. For example, locating the UE may be necessary for the NTN to support some services subject to national regulations or other operational constraints. More specifically, 3GPP TR 22.296 discusses supporting regulated services and features (e.g. Public Warning System, Charging and Billing, Emergency calls, Lawful Intercept, Data Retention Policy) in cross-border scenarios and international regions. Accordingly, it may be beneficial that 3GPP networks have the capability to locate each UE in a reliable manner and determine the appropriate policy that applies to their operation depending on their location and/or context.

Furthermore, in order to meet regulatory requirements, an NTN network may need to enforce that the selected PLMN is allowed to operate in the country of the UE location. This may require the network to verify the UE location during Mobility Management and Session Management procedures, according to some embodiments. More specifically, for network verified UE location based on multi-round trip time (multi-RTT) positioning methods using Rx-Tx time difference measurements with a single satellite, there may be various issues to consider regarding whether or not the multi-RTT report is accurate.

According to some embodiments, multi-RTT positioning methods may need to meet NTN UE location verification accuracy requirement for Low Earth Orbit (LEO) satellites operating at or near 600 km (LEO-600 ). For example, studies have shown that the positioning horizontal accuracy of less than 10 km may be achieved with an over-the-air latency associated with a 95-percentile confidence level (e.g., less or equal to 10 s). Moreover, according to further studies, timing measurement errors of sounding reference signals (SRS) may be smaller than 232 ns with 95% probability. Additionally and according to some scenarios which have been studied, timing measurement errors of positioning reference signals (PRS) may be smaller than 13 ns and 16 ns with 95% probability under the bandwidth of 8.64 MHz and 4.5 MHZ, respectively. Additionally, the satellite's movement between Tx and Rx measurements may have been taken into account in these evaluations.

According to further studies, timing measurement errors may be around 11 ns for PRS detection with PRS bandwidth of 9.36 MHz. Additionally, for the SRS measurement, the maximum timing error may be around 50 ns with SRS bandwidth of 9.36 MHz. Furthermore and according to this scenario, the round trip time (RTT) estimation error may be due to the movement of the satellite and may further be based on a 2-dimensional (2D) positioning method. According to other studies, maximum timing measurement errors of 30 ns, 5 0ns, 100 ns, 200 ns and uniform distribution of timing measurement error may be possible.

In one scenario, timing measurement error of 95 percentile may be equal to 8 ns and 12.6 ns for PRS and SRS respectively with an oversampling of 8. Accordingly, to take into account satellite movement between Tx and Rx measurements, the RTT calculation may be based on an observation that the RTT between a satellite and a UE at time to can be approximated by the sum of the one-way delay at t0-T and the one-way delay at t0+T when T is small (e.g., less than 200 ms), according to this scenario.

Other studies have shown that a positioning horizontal accuracy of less than 10 km may be achieved with 180 seconds latency for an Earth fixed beam with a 90-percentile confidence level. Furthermore, the timing measurement error of SRS and PRS was shown to be smaller than 26.7 ns and 6.1 ns respectively with 95% probability under 30-degree elevation angle for LEO-600. Furthermore, the satellite movement was likely taken into consideration when calculating the RTT in this scenario.

According to some embodiments, multi-RTT positioning methods may require latencies larger than 60 seconds for UEs located near or within the orbital plane of a satellite during a certain time duration. Furthermore, 2D positioning methods may be used (e.g., when UE altitude is known to the network) for better positioning latency/accuracy compared to 3D positioning methods, according to some embodiments.

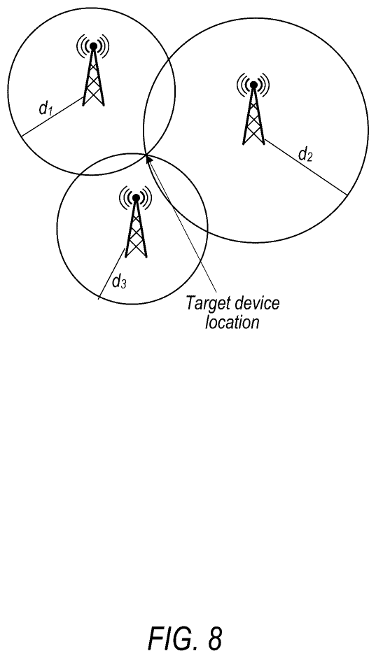

FIG. 8 illustrates aspects of an example method for determining a target device location in a terrestrial network. More specifically, FIG. 8 illustrates the principle of multilateration in two dimensions from three base stations. Multilateration (MLAT, also known as hyperbolic positioning) is the process of locating an object by accurately computing the time difference of arrival (TDOA) of a signal emitted from the object to three or more receivers. In other words, MLAT may be considered as a technique for determining the position of a target device location (e.g., a UE) based on measurement of the times of arrival (TOAs) of energy waves traveling between the target device location and multiple base stations at known locations.

As one example illustrated by FIG. 8, it may be possible for three base stations to determine a target device location based on three respective distance measurements d1, d2, and d3 corresponding to the respective base stations. Accordingly, the target device location may correspond to a position where the measured radii (e.g., respective distances from the respective base stations to the target device) overlap or intersect as shown in FIG. 8. According to some embodiments, MLAT may also be used by the target device to locate itself, by measuring signals emitted from synchronized transmitters at known locations (e.g., the base stations).

More specifically, the method or procedure for determining a target device location may involve determining the distance from an initiating device (e.g., a gNB) to a responding device (e.g., a UE). The procedure of determining the target device location may involve the initiating device (e.g., gNB) sending a control signal to a UE to indicate that one or more gNBs may transmit a RTT measurement signal in downlink (DL). In some embodiments, the DL signal may be a positioning reference signal (PRS). The UE may then measure the times of arrival (TOAs: t1) relative to its own timing and similar to observed time difference of arrival (OTDOA) positioning. The UE may then report the timing measurements in an uplink (UL) RTT measurement signal (t2, t2-t1). In some embodiments, the UL signal may be a sounding reference signal (SRS). Furthermore, the gNBs may measure the observed TOAs and the LMF may extract the UE TOA measurement payload (t2-t1) from the gNB's measured TOA. Accordingly, the RTTs may then be computed from the arrival times of the UL signal (t3), combined with the UE timing information provided in the payload (t2-t1). Finally, the distance d_i from the UE to i-th gNB may be computed.

In some embodiments, the UE may perform UE Rx-Tx time difference measurements (and optionally DL-PRS reference signal received power (RSRP) of the received signals) using assistance data received from a positioning server. Furthermore, the transmission and reception points (TRPs) may measure the gNB Rx-Tx time difference measurements (and optionally UL-SRS-RSRP of the received signals) using assistance data received from the positioning server. Accordingly, the measurements may be used to determine the RTT at the positioning server which are used to estimate the location of the UE (e.g., as described in TS 38.305).

However, due to privacy concerns of the user, it may be beneficial to ensure that the network verified UE location accuracy is more than 2 km, according to some embodiments. Furthermore, issues involving scenarios in which the UE is near or within a satellite orbit plane (which may result in less accurate location information or take a longer time) may benefit from enhanced network verified UE location techniques, according to some embodiments.

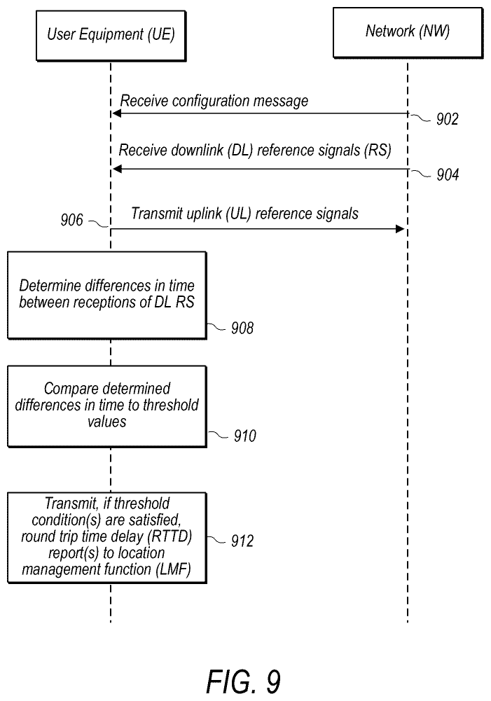

### FIG. 9—Enhanced Location Verification Methods for Non-Terrestrial Networks

FIG. 9 is a flowchart diagram illustrating an example method for enhanced location verification for non-terrestrial networks, according to some embodiments. Aspects of the method of FIG. 9 may be implemented by a wireless device, such as the UE(s) 106, in communication with a network, e.g., via one or more base stations (e.g., BS 102) as illustrated in and described with respect to the Figures, or more generally in conjunction with any of the computer systems or devices shown in the Figures, among other circuitry, systems, devices, elements, or components shown in the Figures, among other devices, as desired. For example, one or more processors (or processing elements) of the UE (e.g., processor(s) 302, baseband processor(s), processor(s) associated with communication circuitry, etc., among various possibilities) may cause the UE to perform some or all of the illustrated method elements. Similarly, one or more processors (or processing elements) of the BS (e.g., processor(s) 404, baseband processor(s), processor(s) associated with communication circuitry, etc., among various possibilities) may cause the UE to perform some or all of the illustrated method elements. In some embodiments, the UE may communicate directly with a base station, and the base station may in turn communicate with an access mobility function (AMF) of a 5GC that services the PLMN associated with the TN. Note that while at least some elements of the method are described in a manner relating to the use of communication techniques and/or features associated with 3GPP specification documents, such description is not intended to be limiting to the disclosure, and aspects of the method may be used in any suitable wireless communication system, as desired. In various embodiments, some of the elements of the methods shown may be performed concurrently, in a different order than shown, may be substituted for by other method elements, or may be omitted. Additional method elements may also be performed as desired. As shown, the method may operate as follows.

At 902, the UE may receive a configuration message from a network node, according to some embodiments. The configuration message may include configuration information such as one or more thresholds for multi-RTT measurement reporting. For example, the one or more thresholds included in the configuration message may specify lengths of time associated with performing round trip time measurements. In some embodiments, the provided threshold(s) may correspond to an upper bound of a total measurement duration. Additionally or alternatively, the provided threshold(s) may serve as an upper bound of two consecutive measurements. In some embodiments, the one or more thresholds may be broadcast via system information block (SIB) signaling.

At 904, the UE may receive downlink (DL) reference signals (RS) from the network, according to some embodiments. For example, having transmitted configuration information regarding multi-RTT reporting to the UE in 902, the network may then transmit DL RS to the UE for performing said multi-RTT reporting. In some embodiments, the DL RS may be positioning reference signals (PRS). Furthermore, the time of transmission of the DL RS by the NW may correspond to time to and the time of reception of the DL RS at the UE may correspond to time t1, according to some embodiments.

At 906, the UE may transmit uplink (UL) reference signals to the network node, according to some embodiments. For example, having received DL RS for multi-RTT reporting in 904, the UE may transmit UL RS to the NW. In some embodiments, the UL RS may be sounding reference signals (SRS). Furthermore, the time of transmission of the UL RS by the UE may correspond to time t2 and the time of reception of the UL RS at the NW may correspond to time t3, according to some embodiments.

At 908, the UE may determine one or more differences in time between the reception(s) of the DL RS, according to some embodiments. For example, as part of an enhanced method of multi-RTT reporting, the UE may calculate a difference in time between multiple receptions of DL RS from the network. More specifically, time t1 may correspond to a time of reception of a first DL RS (transmitted by the network at time t0) and time t′1 may correspond to the time of reception of a second DL RS (transmitted by the network at time t′0), according to some embodiments. Additionally or alternatively, the UE may calculate additional differences in reception times corresponding to additional RTT measurements. For example, as part of a third RTT measurement, the NW may transmit an additional DL RS at time t″0 which may be received at the UE at time t″1. The UE may then transmit additional UL RS at time t″2 which may be received by the network at time t″3. Accordingly, the UE may be able to calculate multiple differences in time for multiple receptions of DL RS corresponding to times t′1, t′1, and t1 (e.g., t″1-t1, t′1-t1, and t″1-t′1). Additionally, for RTTD reporting, the UE may calculate one or more differences in time between reception(s) of DL RS and transmission(s) of UL RS (e.g., t2-t1, t′2-t′1, t″2-t″1). In some embodiments, the UE may also calculate differences in time between transmission of UL RS and reception of DL RS between multiple RTT measurements. For example, the UE may calculate the difference in time between transmission of a third UL RS corresponding to time t″2 and reception of a first DL RS corresponding to time t1 (e.g., t″2-t1). Furthermore, the UE may be able to calculate other differences in time such as the time between transmission of a second UL RS and reception of a first DL RS (e.g., t′2-t1) and transmission of a third UL RS and reception of a second DL RS (e.g., t″2-t′1), according to some embodiments.

At 910, the UE may then compare the determined differences in time to one or more threshold values, according to some embodiments. For example, the UE may compare the determined differences in time to the threshold(s) provided in 902 which may correspond to an upper bound of a total measurement duration (e.g., T1) and/or an upper bound of two consecutive measurements (e.g., T2). More specifically and as one option, the UE may determine if the relations or conditions t″1-t1<T1, t′1-t1<T2, and/or t″1-t′1<T2 are true (e.g., the conditions are satisfied), according to some embodiments. Additionally or alternatively, the UE may determine if the relations or conditions t′2-t1<T1, t′2-t1<T2, and/or t″2-t′1<T2 are true, according to some embodiments.

At 912, the UE may transmit, if the one or more threshold conditions are satisfied, one or more round trip time delay (RTTD) reports to a location management function (LMF), according to some embodiments. In other words, once the UE has determined that certain criteria (e.g., the threshold conditions described in 910) has been met, the UE may appropriately provide RTTD reports to the LMF. Such criteria may be related to restricting lower bounds of UE location verification accuracy in order to address privacy concerns, according to some embodiments. According to some embodiments, if the one or more threshold conditions are not satisfied, the UE may not report the one or more RTTD reports to the LMF.

For example, as part of multi-RTT reporting, the UE may report the difference in time between t2 (e.g., transmission of UL RS by the UE) and t1 (e.g., reception of DL RS by the UE), according to some embodiments. Additionally or alternatively, the UE may calculate multiple RTTDs corresponding to multiple RTT measurements. For example, as part of another RTT measurement, the NW may transmit an additional DL RS at time t′0 which may be received at the UE at time t′1. The UE may then transmit additional UL RS at time t′2 which may be received by the network at time t′3. Accordingly, the UE may be able to calculate the difference in time (e.g., the RTTD) between t′2 and t′1 in addition to the difference in time calculated for t2 and t1 (e.g., the first RTT measurement). In other words, the RTTD reports for three multi-RTT measurements may include RTTDs corresponding to the relations t2-t1 (e.g., a first RTTD), t′2-t′1 (e.g., a second RTTD), and t″2-t″1 (e.g., a third RTTD), according to some embodiments.

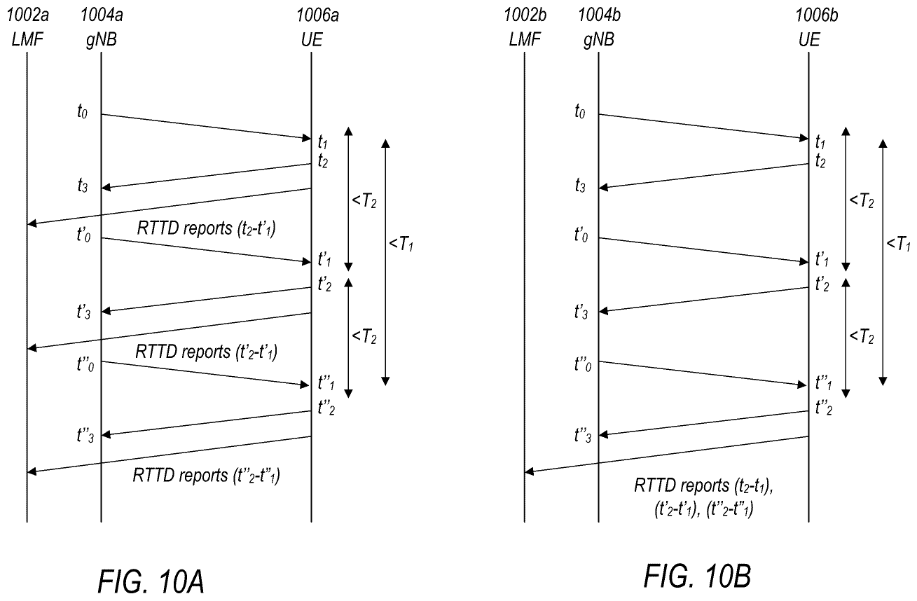

### FIGS. 10A and 10B—Enhanced RTTD Reporting Techniques

FIGS. 10A and 10B illustrate example techniques for enhanced RTTD reporting techniques, according to some embodiments. More specifically, FIGS. 10A and 10B illustrate techniques for restricting lower bounds of UE location verification accuracy in order to address privacy concerns.

In some embodiments involving multi-RTT based positioning in NTN with a view of a single non-geostationary orbit (NGSO) satellite, a UE may perform three measurements by receiving DL PRS, sending UL SRS, and reporting Rx-Tx time differences (e.g., RTTD). For example, in one scenario, a UE may not be required to take more than N number of measurements within a certain time period threshold T1 where T1 may represent an upper bound of the total measurement duration. Accordingly, as one alternative, the UE may not send more than N number of SRS for positioning within a certain time period threshold T1. As another alternative, the UE may not send more than N Rx-Tx time difference reports within a certain time period threshold T1. Moreover, this may be achieved via a UE capability report, according to some embodiments. For example, in Release 16 (Rel-16) New Radio (NR) positioning, a UE capability report may indicate the duration of DL PRS symbols N in units of milliseconds (ms) that a UE is capable of processing every T ms. This may imply a maximum number of DL PRS measurements that are able to be performed within a time duration T, according to some embodiments. Furthermore, with respect to the NTN network verifying the UE's location, it may be possible to indicate a UE capability with the value of T being very large (e.g., on the order of tens of seconds), according to some embodiments.

In another scenario, the UE may not be required to take two consecutive measurements within a certain time period threshold T2 where T2 may represent an upper bound of two consecutive measurements. Accordingly and as one alternative, the UE may not send more than two SRS within a certain time period threshold T2. As another alternative, in the UE reported Rx-Tx time difference reports, the time gap between any two consecutive reports may be no more than T2, according to some embodiments.

In some embodiments, the time period thresholds T1 and T2 may depend on the type of orbit the satellite is in (e.g., LEO-600, LEO-1200, MEO, etc.). For example, according to some embodiments, the higher the satellite's altitude, the larger the time period thresholds T1 and T2 may be. Additionally or alternatively, the time period thresholds T1 and T2 may depend on the total coverage duration of the satellite. For example, the larger the total coverage duration, the larger the time period thresholds T1 and T2 may be. Additionally or alternatively, the time period thresholds T1 and T2 may depend on an elevation angle of the coverage. In some embodiments, the time period thresholds T1 and T2 may be broadcast via SIB (e.g., SIB1, SIB19 or another type of SIB).

Accordingly, FIG. 10A illustrates an example method for reporting multiple RTTD reports to the LMF after each multi-RTT measurement while FIG. 10B illustrates reporting the multiple RTTD reports to the LMF after all of the measurements have been performed, according to some embodiments. In other words, while FIG. 10A describes a “multiple shot reports” scenario in which the UE reports RTTD to the LMF after each measurement (e. g, after respective SRS(s) has been received at the gNB at times t3, t′3, and t″3), according to some embodiments.

Alternatively, FIG. 10B illustrates an example of a “one-shot report” in which the UE reports multiple RTTDs simultaneously, according to some embodiments. For example, instead of transmitting the RTTD reports after each measurement as in FIG. 10A, FIG. 10B describes a method in which the RTTD reports are all sent on one transmission after all the appropriate measurements have been performed (and threshold conditions have been satisfied), according to some embodiments. As a result of reducing the number of transmissions, this may result in conservation of power as compared to the “multiple shot reporting” of FIG. 10A, according to some embodiments.

In some embodiments related to the “one-shot report” of FIG. 10B, each RTTD report may be associated with a timestamp. More specifically, each time stamp of t₁ may be associated with the first RTTD report (t₂-t₁), time stamp of t′₁ may be associated with the second RTTD report (t′₂-t′₁), and time stamp of t″₁ may be associated with the third RTTD report (t″₂-t″₁), etc. According to some embodiments, the time stamp may be in the form of system frame number (SFN) and slot index, symbol index, and/or in the form of coordinated universal time (UTC). In some embodiments, both the RTTD reports and timestamps may be reported by the UE to the LMF.

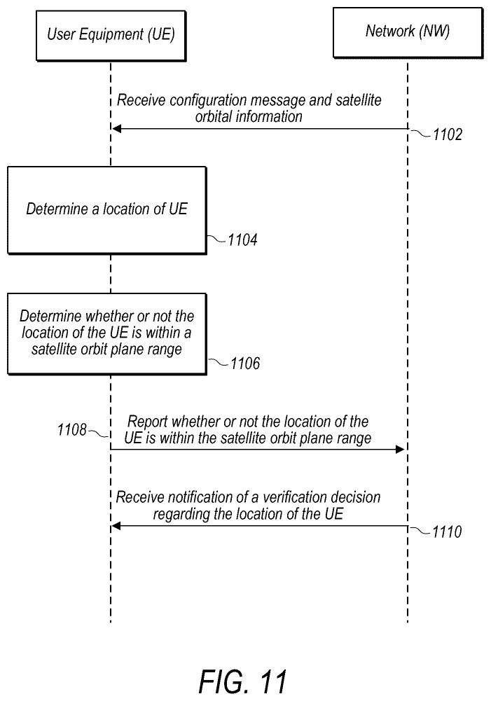

### FIG. 11—Enhanced Location Verification Methods for UEs Near or Within Satellite Orbit Planes

According to some embodiments, for a UE near satellite orbit plane, the location verification may not be very accurate (e.g., more than 10 km) or the measurement may take much longer time than latency requirement. Accordingly, it may be beneficial to describe techniques for enhanced location verification when the UE is near or within the satellite orbit plane.

FIG. 11 is a flowchart diagram illustrating an example method for enhanced location verification for UEs near or within satellite orbit planes, according to some embodiments. Aspects of the method of FIG. 11 may be implemented by a wireless device, such as the UE(s) 106, in communication with a network, e.g., via one or more base stations (e.g., BS 102) as illustrated in and described with respect to the Figures, or more generally in conjunction with any of the computer systems or devices shown in the Figures, among other circuitry, systems, devices, elements, or components shown in the Figures, among other devices, as desired. In some embodiments, the network may refer to a gNB, a satellite, an AMF (Access and mobility Management Function) an LMF (Location Management Function), or any combination of these entities. For example, one or more processors (or processing elements) of the UE (e.g., processor(s) 302, baseband processor(s), processor(s) associated with communication circuitry, etc., among various possibilities) may cause the UE to perform some or all of the illustrated method elements. Similarly, one or more processors (or processing elements) of the BS (e.g., processor(s) 404, baseband processor(s), processor(s) associated with communication circuitry, etc., among various possibilities) may cause the UE to perform some or all of the illustrated method elements. In some embodiments, the UE may communicate directly with a base station, and the base station may in turn communicate with an access mobility function (AMF) of a 5GC that services the PLMN associated with the TN. Note that while at least some elements of the method are described in a manner relating to the use of communication techniques and/or features associated with 3GPP specification documents, such description is not intended to be limiting to the disclosure, and aspects of the method may be used in any suitable wireless communication system, as desired. In various embodiments, some of the elements of the methods shown may be performed concurrently, in a different order than shown, may be substituted for by other method elements, or may be omitted. Additional method elements may also be performed as desired. As shown, the method may operate as follows.

At 1102, the UE may receive a configuration message and satellite orbital information from a network node, according to some embodiments. For example, the network may broadcast configuration information related to the satellite orbit plane range in addition to satellite ephemeris information. The satellite ephemeris information (e.g., the satellite orbital information) may include information related to the trajectory of one or more NTN satellites in the sky (e.g., the position and possibly velocity) over time, according to some embodiments. Furthermore, according to some embodiments, the configuration message may include a configuration of a satellite orbit plane range which may specify a value “D” related to the projected orbit plane on the ground. In other words, “D” may represent a distance or range from a central path of the orbit projected on the Earth's surface (e.g., a ground track/trace) in order to represent an area (e.g., a band or strip of land) corresponding to the satellite's orbit plane projected on the ground.

In some embodiments, the configuration message may be transmitted in system information broadcast (SIB) messaging (e.g., SIB1, SIB19 or another SIB) or dedicated radio resource control (RRC) signaling. The configuration message may include information related to the satellite orbit plane range “D” which may further be indicated in units of km or meters, according to some embodiments. The satellite orbit plane range “D” may indicate a range or distance from the ground track which corresponds to the satellite orbit plane, according to some embodiments. Furthermore, The satellite orbit plane range “D” may depend on the satellite scenario (LEO-600, LEO-1200, MEO), according to some embodiments. For example, the higher the satellite altitude, the larger the value of “D” may be (e.g., a larger satellite orbit plane range). Additionally or alternatively, multiple “D” values may be configured to determine the different levels of UE distance to a satellite orbit plane. For example, one “D” value may be set such that the network implementation (such as angle of arrival (AoA)) based solution (e.g., due to AoA granularity) can not address the mirror-image ambiguity issue, according to some embodiments.

At 1104, the UE may determine its location, according to some embodiments. For example, the UE may be able to determine its physical location through use of its global navigation satellite system (GNSS) hardware and/or software. In other words, the UE may be able to determine coarse UE location information (coarse GNSS coordinates with an accuracy of approximately 2 km), according to some embodiments. According to some embodiments, the UE may optionally report its coarse location (e.g., UE location information) to the network for the network to perform its own determination regarding the UE's location with respect to the satellite orbit plane.

At 1106, the UE may determine whether or not the location of the UE is within a satellite orbit plane range, according to some embodiments. For example, the UE may utilize information from the satellite ephemeris or orbital information provided from the network in 1102 to determine a ground trace (e.g., ground track) of the satellite orbit. The UE may calculate the minimum distance (dmin) from its GNSS location and the satellite orbit ground trace and compare the minimum distance (dmin) with the received configured satellite orbit plane range “D”. Accordingly, if the minimum distance (dmin) is smaller than D, then the UE may be considered to be within the satellite orbit plane range. Otherwise, if the minimum distance (dmin) is larger than D, the UE may be considered to be outside the satellite orbit plane range, according to some embodiments. Accordingly, the UE may be able to make a determination of whether or not it is located within the satellite orbit plane range, according to some embodiments.

At 1108, the UE may report, to the network node, whether or not the location of the UE is within the satellite orbit plane range, according to some embodiments. For example, having compared the UE's determined location to the configured satellite orbit plane range in 1106 and determined whether or not it is located within the satellite orbital plane range, the UE may report or indicate this determination to the network, according to some embodiments. Accordingly, this may be considered an explicit indication of whether or not the UE is within the satellite orbit plane range.

In some embodiments, the indication may be a single bit to indicate whether or not the UE is within the satellite orbit plane range. Alternatively, the indication may be multiple bits to indicate at which level the UE is within the satellite orbit plane range. In some embodiments, the indication may be transmitted via dedicated radio resource control (RRC) signaling or medium access control-control element (MAC-CE) signaling. Additionally or alternatively, the UE may report whether it is within the coverage of one or more other satellites. Furthermore, the UE may include information related to the determination of whether it is in the satellite orbit plane range. For example, the UE may include information such as its determined location (e.g., UE location information) as well as any orbital information it may have used to make said determination, according to some embodiments.

According to some embodiments, the UE may opt to not report an indication of whether or not the location of the UE is within the satellite orbit plane range. For example, if the UE reported its coarse location (e.g., UE location information) to the network (as optionally described in 1104), the network may be able to use this information to perform its own determination regarding the UE's location with respect to the satellite orbit plane. In other words, this may be considered an implicit indication of whether or not the UE is within the satellite orbit plane range.

At 1110, the UE may receive, from the network node, a notification or indication of a verification decision regarding the location of the UE, according to some embodiments. For example, if the received indication of 1108 corresponds to the UE being within the orbit plane range, the network may decide to not verify the UE's location. In some embodiments, the network may decide whether or not to verify a UE's location based on if there is another satellite covering the UE at a certain time period. Accordingly, if there are other satellites covering this area of the UE, then multi-RTT reporting may be performed and the network may not need to verify the UE's location, according to some embodiments.

Additionally or alternatively, the network may apply different sets of parameters as part of a verification procedure of the UE's location. For example, one set of thresholds T1 and T2 may be applied for a UE's location verification if UE is within the orbit plane range. Alternatively, another set of thresholds different than T1 and T2 may be applied for a UE's location verification if UE is outside the orbit plane range. Accordingly, in 1110, the network may notify the UE of its decision of whether or not to verify the UE's location, according to some embodiments. The notification or indication may be delivered via dedicated RRC signaling, according to some embodiments.

According to some embodiments, the UE may not receive a notification or indication of a verification decision regarding the location of the UE. For example, if the network implicitly determined whether or not the UE was within the satellite orbit plane range (through use of the optionally received UE coarse location information described in 1104), the network may choose to not inform the UE of a decision related to verification of the UE location. In other words, it may not be necessary to inform or notify the UE of any network based decision regarding the UE location if the provided location is accurate and/or the UE is not affected by the satellite orbital plane. Accordingly, this reduction in transmissions could be beneficial for power conservation purposes.

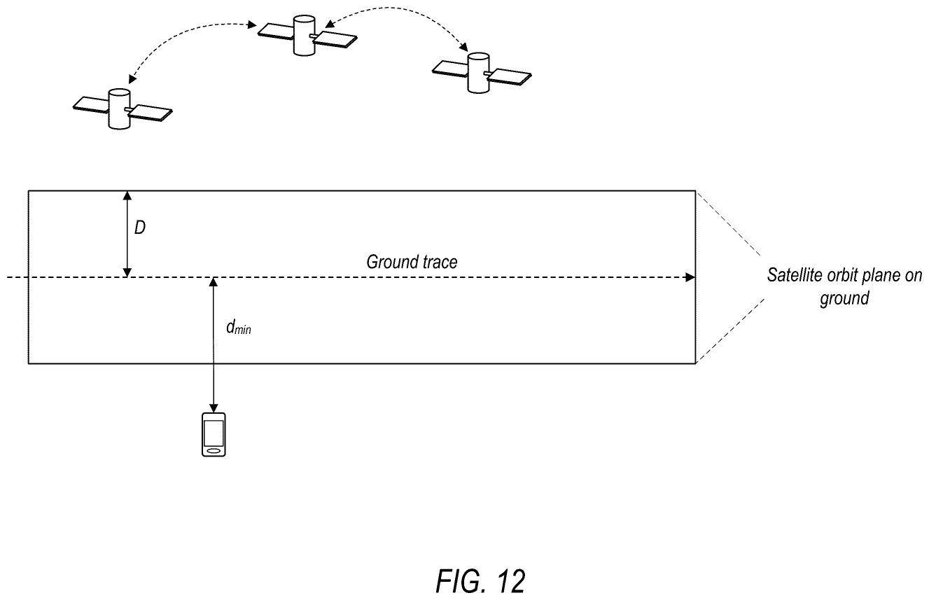

### FIG. 12—Location Verification and Configuration for UE Located Near or Within a Satellite Orbit Plane

FIG. 12 illustrates an example satellite orbit plane in which a UE may be near or within, according to some embodiments. More specifically, FIG. 12 illustrates example aspects of location verification and configuration for UEs located near or within a satellite orbit plane. For example, as illustrated by FIG. 12, “D” may correspond to a range or distance from a central path corresponding to the satellite's orbital project path on the ground.

For example, a ground track or ground trace may be considered the path on the surface of a planet directly below an aircraft's or satellite's trajectory. For satellites, a ground track or ground trace may also be known as a suborbital track. Accordingly, it may be considered to be the vertical projection of the satellite's orbit onto the surface of the Earth (or other planet or body the satellite is orbiting). In other words, a satellite ground track may be considered as a path along the Earth's surface that traces the movement of an imaginary line between the satellite and the center of the Earth. More specifically, the ground track may be considered to be a line or set of points at which the satellite will pass directly overhead (e.g., cross the zenith), in the frame of reference of a ground observer.

In other words, “D” may indicate a range or distance from the ground track which corresponds to the satellite orbit plane. Accordingly, if a UE determines its location to be a distance less than “D” from the central orbit path, the UE may be considered to be within the satellite orbital plane. Alternatively, if the UE determines its location to be at a distance greater than “D”, the UE may be considered to be outside the satellite orbit plane range. The satellite orbit plane range “D” may depend on the satellite scenario (LEO-600, LEO-1200, MEO), according to some embodiments. For example, the higher the satellite altitude, the larger the value of “D” may be (e.g., a larger satellite orbit plane range). Additionally or alternatively, multiple “D” values may be configured to determine the different levels of UE distance to a satellite orbit plane. For example, one “D” value may be set such that the network implementation (such as angle of arrival (AoA)) based solution (e.g., due to AoA granularity) can not address the mirror-image ambiguity issue.

### Example Embodiments

According to some embodiments, a method may include receiving, from a network node, a configuration message comprising one or more thresholds for multiple round trip time (multi-RTT) measurement reporting. The method may further include receiving, from the network node, a plurality of downlink (DL) reference signals (RS) for one or more multi-RTT measurements and transmitting, to the network node, a plurality of uplink (UL) reference signals (RS) for the one or more multi-RTT measurements, wherein respective UL RS of the plurality of UL RS are transmitted in response to receiving respective DL RS of the plurality of DL RS. Additionally, the method may include determining one or more respective differences in time between at least one of respective reception times of the plurality of DL RS and determining whether or not the one or more respective differences in time are less than the one or more thresholds for multi-RTT measurement reporting. Furthermore, if the one or more respective differences in time are less than the one or more thresholds for multi-RTT measurement reporting, the method may further include transmitting, to a location management function (LMF), one or more round trip time delay (RTTD) reports for the one or more multi-RTT measurements.

In some embodiments, a first threshold of the one or more thresholds may be associated with an upper bound of a total measurement duration and a second threshold of the one or more thresholds may correspond to an upper bound of two consecutive measurements for the total measurement duration. Additionally or alternatively, wherein the one or more thresholds are based on at least one of one or more satellite altitudes, one or more satellite total coverage durations, and one or more satellite elevation angles.

According to further embodiments, the plurality of DL RS may be positioning reference signals (PRS) and the plurality of UL RS may be sounding reference signals (SRS). In some embodiments, respective RTTD reports of the one or more RTTD reports may be transmitted to the LMF after respective transmissions of the one or more UL RS or a RTTD report of the one or more RTTD reports may be transmitted to the LMF after the one or more UL RS have been transmitted. Additionally or alternatively, respective RTTD reports of the one or more RTTD reports may include respective timestamps.

In some embodiments, the method may further include determining one or more additional differences in time between at least one of respective reception times of the plurality of DL RS and respective transmission times of the plurality of UL RS. Additionally, the method may include determining whether or not the one or more additional differences in time are less than the one or more thresholds for multi-RTT measurement reporting. If the one or more additional differences in time are less than the one or more thresholds for multi-RTT measurement reporting, the method may further include transmitting, to the LMF, the one or more RTTD reports for the one or more multi-RTT measurements, according to some embodiments.

According to further embodiments, a method may include receiving, from a network node, one or more messages including at least one of a configuration of a satellite orbit plane range and satellite orbital information. The method may further include determining, using a global navigation satellite system (GNSS), a location of a user equipment (UE). The method may include determining, based at least in part on one or more of the satellite orbit plane range, the satellite orbital information, and the location of the UE, whether or not the location of the UE is within the satellite orbit plane range. Additionally, the method may include reporting, to the network node, an indication of whether or not the location of the UE is within the satellite orbit plane range and receiving, from the network node, a notification of a decision regarding the location of the UE.

In some embodiments, the one or more messages may be received via system information broadcast (SIB) signaling or dedicated radio resource control (RRC) signaling. Additionally or alternatively, the configuration of the satellite orbit plane range may specify a range of the satellite orbit on the ground in meters (m) or kilometers (km). In some embodiments, the one or more messages may include a plurality of satellite orbit plane ranges.

According to further embodiments, the method may further include calculating, using the satellite orbital information and the location of the UE, a minimum distance and comparing the minimum distance to the configured satellite orbit plane range. Accordingly, if the minimum distance is smaller than the configured satellite orbit plane range, the UE may be within the configured satellite orbit plane range or if the minimum distance is greater than the configured satellite orbit plane range, the UE may be outside the configured satellite orbit plane range.

According to some embodiments, the indication may be included in a single bit to indicate whether or not the UE is within the satellite orbit plane range. Additionally or alternatively, the indication may be included in multiple bits to indicate at which level the UE is within the satellite orbit plane range, according to some embodiments. In some embodiments, the indication may be transmitted via dedicated radio resource control (RRC) signaling or medium access control-control element (MAC-CE) signaling.

In some embodiments, a method may include transmitting, to a user equipment (UE), at least one of a configuration of a satellite orbit plane range and satellite orbital information. The method may further include receiving, from the UE, a location of the UE and determining, based at least in part on one or more of the satellite orbit plane range, the satellite orbital information, and the location of the UE, whether or not the UE is within the satellite orbit plane range. Accordingly, if the UE's location is determined to be outside the satellite orbit plane range, the method may further include performing multilateration positioning to verify the location of the UE. Additionally or alternatively, if the UE's location is determined to be outside the satellite orbit plane range, the method may further include transmitting, to the UE via dedicated radio resource control (RRC) signaling, an indication to the UE indicating a verification of the location of the UE.

Aspects of the aforementioned methods may be implemented by a wireless device, such as the UE(s) 106, in communication with a network, e.g., via one or more base stations (e.g., BS 102) as illustrated in and described with respect to the Figures, or more generally in conjunction with any of the computer systems or devices shown in the Figures, among other circuitry, systems, devices, elements, or components shown in the Figures, among other devices, as desired.

Additionally or alternatively, aspects of the aforementioned methods may also be implemented by one or more base stations (e.g., BS 102) in communication with a wireless device, such as the UE(s) 106, e.g., via as illustrated in and described with respect to the Figures, or more generally in conjunction with any of the computer systems or devices shown in the Figures, among other circuitry, systems, devices, elements, or components shown in the Figures, among other devices, as desired.

In some embodiments, a method may include transmitting, to a user equipment (UE), at least one of a configuration of a satellite orbit plane range and satellite orbital information. The method may further include receiving, from the UE, a location of the UE and determining, based at least in part on one or more of the satellite orbit plane range, the satellite orbital information, and the location of the UE, whether or not the UE is within the satellite orbit plane range. Accordingly, if the UE's location is determined to be outside the satellite orbit plane range, the method may further include performing multilateration positioning to verify the location of the UE. Additionally or alternatively, if the UE's location is determined to be outside the satellite orbit plane range, the method may further include transmitting, to the UE via dedicated radio resource control (RRC) signaling, an indication to the UE indicating a verification of the location of the UE.

It should be appreciated that, in various embodiments, some of the elements of the method shown may be performed concurrently, in a different order than shown, may be substituted for by other method elements, or may be omitted, and/or additional method elements may be performed as desired.

Embodiments of the present disclosure may be realized in any of various forms. For example, some embodiments may be realized as a computer-implemented method, a computer-readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., a UE) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

In some embodiments, a device includes: an antenna; a radio coupled to the antenna; and a processing element coupled to the radio. The device may be configured to implement any of the method embodiments described above.

In some embodiments, a memory medium may store program instructions that, when executed, cause a device to implement any of the method embodiments described above.

In some embodiments, an apparatus includes: at least one processor (e.g., in communication with a memory), that is configured to implement any of the method embodiments described above.

In some embodiments, a method includes any action or combination of actions as substantially described herein in the Detailed Description and claims.

In some embodiments, a method is performed as substantially described herein with reference to each or any combination of the Figures contained herein, with reference to each or any combination of paragraphs in the Detailed Description, with reference to each or any combination of Figures and/or Detailed Description, or with reference to each or any combination of the claims.

In some embodiments, a wireless device is configured to perform any action or combination of actions as substantially described herein in the Detailed Description, Figures, and/or claims.

In some embodiments, a wireless device includes any component or combination of components as described herein in the Detailed Description and/or Figures as included in a wireless device.

In some embodiments, a non-volatile computer-readable medium may store instructions that, when executed, cause the performance of any action or combination of actions as substantially described herein in the Detailed Description and/or Figures.

In some embodiments, an integrated circuit is configured to perform any action or combination of actions as substantially described herein in the Detailed Description and/or Figures.

In some embodiments, a mobile station is configured to perform any action or combination of actions as substantially described herein in the Detailed Description and/or Figures.

In some embodiments, a mobile station includes any component or combination of components as described herein in the Detailed Description and/or Figures as included in a mobile station.

In some embodiments, a mobile device is configured to perform any action or combination of actions as substantially described herein in the Detailed Description and/or Figures.

In some embodiments, a mobile device includes any component or combination of components as described herein in the Detailed Description and/or Figures as included in a mobile device.

In some embodiments, a network node is configured to perform any action or combination of actions as substantially described herein in the Detailed Description and/or Figures.

In some embodiments, a network node includes any component or combination of components as described herein in the Detailed Description and/or Figures as included in a mobile device.

In some embodiments, a base station is configured to perform any action or combination of actions as substantially described herein in the Detailed Description and/or Figures.

In some embodiments, a base station includes any component or combination of components as described herein in the Detailed Description and/or Figures as included in a mobile device.

In some embodiments, a 5G NR network node or base station is configured to perform any action or combination of actions as substantially described herein in the Detailed Description and/or Figures.

In some embodiments, a 5G NR network node or base station includes any component or combination of components as described herein in the Detailed Description and/or Figures as included in a mobile device.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Any of the methods described herein for operating a user equipment (UE) may be the basis of a corresponding method for operating a base station, by interpreting each message/signal X received by the UE in the downlink as message/signal X transmitted by the base station, and each message/signal Y transmitted in the uplink by the UE as a message/signal Y received by the base station.

Although the embodiments above have been described in considerable detail, numerous variations and modifications will become apparent to those skilled in the art once the above disclosure is fully appreciated. It is intended that the following claims be interpreted to embrace all such variations and modifications.

In some embodiments, a non-transitory computer-readable memory medium (e.g., a non-transitory memory element) may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE) may be configured to include a processor (or a set of processors) and a memory medium (or memory element), where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

1. A method, comprising:
receiving, from a network node, a configuration message comprising one or more thresholds for multiple round trip time (multi-RTT) measurement reporting;
receiving, from the network node, a plurality of downlink (DL) reference signals (RS) for one or more multi-RTT measurements;
transmitting, to the network node, a plurality of uplink (UL) RS for the one or more multi-RTT measurements, wherein respective UL RS of the plurality of UL RS are transmitted in response to receiving respective DL RS of the plurality of DL RS;
determining one or more respective differences in time between respective reception times of the plurality of DL RS; and
determining whether or not the one or more respective differences in time are less than the one or more thresholds for multi-RTT measurement reporting, wherein if the one or more respective differences in time are less than the one or more thresholds for multi-RTT measurement reporting, the method further comprises:
transmitting, to a location management function (LMF), one or more round trip time delay (RTTD) reports for the one or more multi-RTT measurements.

2. The method of claim 1, wherein:
a first threshold of the one or more thresholds is associated with an upper bound of a total measurement duration, and
a second threshold of the one or more thresholds is associated with an upper bound of two consecutive measurements for the total measurement duration.

3. The method of claim 1, wherein the one or more thresholds are based on at least one of:
one or more satellite altitudes;
one or more satellite total coverage durations; and
one or more satellite elevation angles.

4. The method of claim 1, wherein the plurality of DL RS are positioning reference signals (PRS) and the plurality of UL RS are sounding reference signals (SRS).

5. The method of claim 1, wherein:
respective RTTD reports of the one or more RTTD reports are transmitted to the LMF after respective transmissions of the plurality of UL RS; or
a RTTD report of the one or more RTTD reports is transmitted to the LMF after the plurality of UL RS have been transmitted.

6. The method of claim 1, wherein respective RTTD reports of the one or more RTTD reports comprise respective timestamps.

7. The method of claim 1, further comprising:
determining one or more additional differences in time between at least one of respective reception times of the plurality of DL RS and respective transmission times of the plurality of UL RS; and
determining whether or not the one or more additional differences in time are less than the one or more thresholds for multi-RTT measurement reporting, wherein if the one or more additional differences in time are less than the one or more thresholds for multi-RTT measurement reporting, the method further comprises:
transmitting, to the LMF, the one or more RTTD reports for the one or more multi-RTT measurements.

8. A method, comprising:
receiving, from a network node, one or more messages comprising at least one of a configuration of a satellite orbit plane range and satellite orbital information;
determining, using a global navigation satellite system (GNSS), a location of a user equipment (UE);
determining, based at least in part on one or more of the satellite orbit plane range, the satellite orbital information, and the location of the UE, whether or not the location of the UE is within the satellite orbit plane range;
reporting, to the network node, an indication of whether or not the location of the UE is within the satellite orbit plane range; and
receiving, from the network node, a notification of a decision regarding the location verification of the UE.

9. The method of claim 8, wherein the one or more messages are received via system information broadcast (SIB) signaling or dedicated radio resource control (RRC) signaling.

10. The method of claim 8, wherein the configuration of the satellite orbit plane range specifies a range of the satellite orbit on the ground in meters (m) or kilometers (km).

11. The method of claim 8, wherein the one or more messages comprise a plurality of satellite orbit plane ranges.

12. The method of claim 8, further comprising:
calculating, using the satellite orbital information and the location of the UE, a minimum distance.

13. The method of claim 12, further comprising:
comparing the minimum distance to the configured satellite orbit plane range, wherein:
if the minimum distance is smaller than the configured satellite orbit plane range, the UE is within the configured satellite orbit plane range; or
if the minimum distance is greater than the configured satellite orbit plane range, the UE is outside the configured satellite orbit plane range.

14. The method of claim 8, wherein the indication is comprised in at least one of the following:
a single bit to indicate whether or not the UE is within the satellite orbit plane range; and
multiple bits to indicate at which level the UE is within the satellite orbit plane range.

15. The method of claim 8, wherein the indication transmitted via dedicated radio resource control (RRC) signaling or medium access control-control element (MAC-CE) signaling.

16. A method, comprising:
transmitting, to a user equipment (UE), at least one of a configuration of a satellite orbit plane range and satellite orbital information;
receiving, from the UE, a location of the UE;
determining, based at least in part on one or more of the satellite orbit plane range, the satellite orbital information, and the location of the UE, whether or not the UE is within the satellite orbit plane range, wherein if the UE's location is determined to be outside the satellite orbit plane range, the method further comprises:
performing multilateration positioning to verify the location of the UE.

17. The method of claim 16, wherein if the UE's location is determined to be outside the satellite orbit plane range, the method further comprises:
transmitting, to the UE via dedicated radio resource control (RRC) signaling, an indication to the UE indicating a verification of the location of the UE.

18.-20. (canceled)

21. The method of claim 17, wherein the indication is comprised in at least one of the following:
a single bit to indicate whether or not the UE is within the satellite orbit plane range; and
multiple bits to indicate at which level the UE is within the satellite orbit plane range.

22. The method of claim 16, wherein the configuration of the satellite orbit plane range specifies a range of the satellite orbit on the ground in meters (m) or kilometers (km).

23. The method of claim 16, further comprising:
calculating, using the satellite orbital information and the location of the UE, a minimum distance.
